(19) United States
(12) Patent Application Publication
(10) Pub. No.: US 2024/0067092 A1
(43) Pub. Date: Feb. 29, 2024

(54) REARVIEW ASSEMBLY WITH ILLUMINATION

(71) Applicant: GENTEX CORPORATION, Zeeland, MI (US)

(72) Inventors: Michael F. Lisowski, Holland, MI (US); Richard T. Fish, Hudsonville, MI (US); Steven J. Veenman, Hudsonville, MI (US); Bradley R. Hamlin, Allendale, MI (US)

(73) Assignee: GENTEX CORPORATION, Zeeland, MI (US)

(21) Appl. No.: 17/896,640

(22) Filed: Aug. 26, 2022

(51) Int. Cl. B60R 1/12; B60Q 1/26

(52) U.S. Cl. CPC B60R 1/1207; B60Q 1/2665

(57) ABSTRACT

The present disclosure is directed to an illumination and imaging system, which may comprise a housing, a transflective element, a light source, and an optic apparatus. The housing may have a cavity with an opening. The transflective element may be substantially aligned with the opening. The light source may be disposed within the cavity. The optic apparatus may also be disposed within the cavity and have a collimator optic and a spreader optic. The collimator optic may be configured to collimate light emitted from the light source toward the transflective element. The spreader optic may be disposed proximate the transflective element and configured to transmit and spread the collimated light for transmission through the transflective element to substantially illuminate the vehicle interior.

### FIELD OF INVENTION

The present invention relates, in general, to rearview assemblies and, more particularly, to rearview assemblies with IR or NIR illumination.

### BACKGROUND OF INVENTION

There is an increasing demand for the incorporation of cabin and/or driver monitoring systems into vehicles. These systems often rely on cameras that image the cabin and/or driver in the infra-red or near infra-red region of the electromagnetic spectrum. Obtaining sufficient image quality often requires infra-red or near infra-red illumination via a light source. Further, it is often necessary that the light source be placed in a forward position of the vehicle. Therefore, it is desirable to place light sources in rearview assemblies. Additionally, to in pursuit of a pleasing aesthetic, it is further desirable to place these light sources behind a transflective element of the rearview assemblies. However, light sources in this location may have the disadvantage of the illumination being visible through the transflective element and within the driver's field of view in the rearview assembly. This visibility may even occur despite being outside of the “visible region,” as the human eye has a small but demonstrable sensitivity to light around used wavelengths. This may negatively impact the aesthetic of the rearview assembly. This impact may be greater in prior apparatuses due to the size of the illuminated region. Accordingly, there is a need for improved devices and systems for illuminating a cabin and/or a driver with reduced or eliminated visibility.

### SUMMARY

In accordance the present disclosure, the problems associated with illuminating a cabin and/or driver with in the infra-red and/or near infra-red regions of the electromagnetic spectrum are substantially reduced or eliminated.

According to one aspect of the present disclosure, a rearview assembly is disclosed. The rearview assembly may comprise a housing, a transflective element, a light source, and an optic apparatus. The housing may have a cavity with an opening. The transflective element may be substantially aligned with the opening. Additionally, the transflective element may have a first side directed exterior the cavity and a second side directed interior the cavity. In some embodiments, the transflective element comprises an electrochromic element operable to vary the reflectance of the transflective element. The light source may disposed within the cavity and configured to emit at least one of infra-red and near infra-red light. The optic apparatus may be disposed within the cavity. Further, the optic apparatus may have a collimator optic and a spreader optic. The collimator optic may be configured to collimate the emitted light toward the transflective element. The spreader optic may be disposed proximate the second side and configured to transmit and spread the collimated light. The spread light is transmitted through the transflective element to substantially illuminate a vehicle interior. In some embodiments, the spreader optic comprises a diffuser. Additionally or alternatively, the spreader optic may comprise one or more prism film.

In some embodiments, the light may be spread by at least 75 degrees in both directions from center in an X axis. The X axis may correspond to a horizontal direction in relation to looking directly at the first side under normal operating conditions. Additionally or alternatively, the light may be spread by at least 15 degrees up and 80 degrees down from center in a Y axis. The Y axis may correspond to a vertical direction in relation to looking directly at the first side under normal operating conditions

In some embodiments, the rearview assembly may further comprise a foam layer. The foam layer may be associated with the second side. Additionally, the foam layer may have an aperture. Further, the spreader optic may be substantially disposed within the aperture.

In some embodiments, the rearview assembly may further comprise a circuit board. The circuit board may have a substantial set-back from the transflective element. Additionally, the light source may be physically associated with the circuit board. In some such embodiments, the rearview assembly may further comprise an imager disposed within the cavity. Additionally, the imager may be physically associated with the circuit board.

These and other aspects, objects, and features of the present disclosure will be understood and appreciated by those skilled in the art upon studying the following specification, claims, and appended drawings. It will also be understood that features of each embodiment disclosed herein may be used in conjunction with, or as a replacement for, features in other embodiments.

### BRIEF DESCRIPTION OF FIGURES

In the drawings:

FIG. 1 is a cross-sectional schematic representation of an embodiment of a rearview assembly;

FIG. 2 is a cross-sectional schematic representation of an embodiment of a transflective element; and

FIG. 3 is a schematic representation of an embodiment of an illumination and imaging system.

### DETAILED DESCRIPTION

For the purposes of description herein, the specific devices and processes illustrated in the attached drawings and described in this disclosure are simply exemplary embodiments of the inventive concepts defined in the appended claims. Hence, specific characteristics relating the embodiments disclosed herein are not limiting, unless the claims expressly state otherwise.

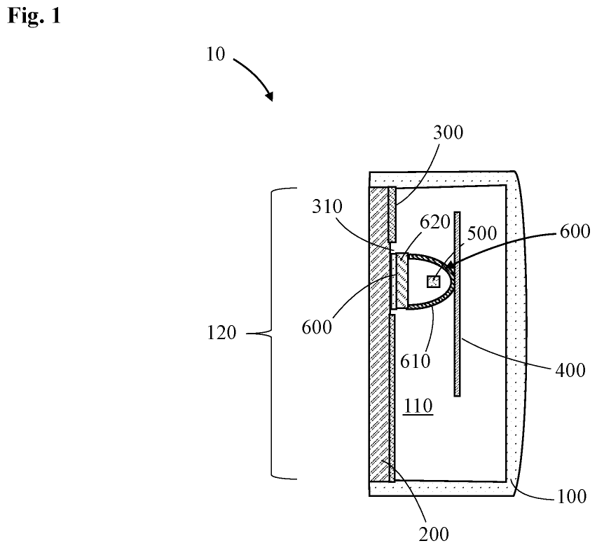

The present disclosure is directed to an illumination and imaging system 10. Accordingly, FIGS. 1-3, illustrate various aspects of illumination and imaging system 10. Illumination and imaging system 10 may comprise a housing 100, a transflective element 200, a foam layer 300, a circuit board 400, a light source 500, an optic apparatus 600, a light filter 700, and/or an imager 800. As such, illumination and imaging system 10 may be part of a rearview assembly. Further, the rearview assembly may be configured for association with a vehicle interior and to provide a driver with a view of a scene rearward relative the vehicle.

Housing 100 may be a housing of the rearview assembly. The rearview assembly may be disposed in a vehicle interior. Accordingly, housing 100 may be mounted to the interior of the vehicle. In some embodiments, housing 100 may be mounted, more specifically, at a windshield of the vehicle. Further, housing 100 may form a cavity 110 there within. Cavity 110 may additionally have an opening 120. Opening 120 may be defined by housing 100 such that opening 120 substantially faces the driver.

Transflective element may be disposed such that it is in substantial alignment with and/or substantially disposed in opening 120. Further, transflective element 200 may have a first side 201 and a second side 202. First side 201 may be directed to an exterior of cavity 110. As such, first side 201 may face the driver. Conversely, second side 202 may be directed to an interior of cavity 110. Additionally, transflective element 200 may be configured and/or operable to substantially transmit light in a first wavelength range from the interior of cavity 110 to the exterior of cavity 110. In some embodiments, transflective element 200 may also be configured and/or operable to substantially transmit light in the first wavelength range from the exterior of cavity 110 to the interior of cavity 110. The first wavelength range may substantially correspond to part of the infra-red and/or near infra-red regions of the electromagnetic spectrum. Additionally, transflective element 200 may be further configured and/or operable to reflect visible light from exterior cavity 110. By reflecting visible light from exterior cavity 110, transflective element 200 may be configured and/or operable to serve as a visible spectrum mirror and provide the driver with the view of the scene rearward relative the vehicle.

First side 201 may lie in a plane. In relation to this plane, X, Y, and Z axes may be defined from a perspective of a driver or user looking directly at first side 201 under normal operating conditions. The X axis may correspond to a horizontal direction. Conversely, the Y axis may correspond to a vertical direction. The Z axis may correspond to a direction traversing and substantially orthogonal to the plane, such that it extends directly to or away from the driver or user. Accordingly, the X, Y, and Z axes may each be orthogonal to one another.

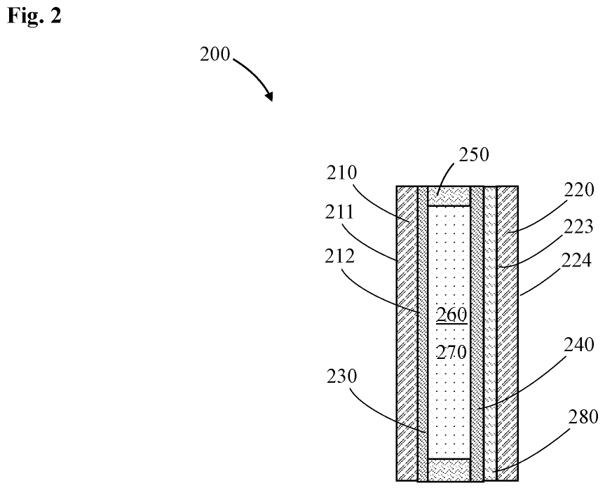

In some embodiments, as shown in FIG. 2, transflective element 200 may be an electro-optic element. Thus, transflective element 200 may be configured and/or operable to vary the degree of visible light reflectance. Accordingly, transflective element 200 may comprise a first substrate 210, a second substrate 220, a first electrode 230, a second electrode 240, a seal 250, a chamber 260, electro-optic medium 270, and/or a reflective element 280.

First substrate 210 comprises a first surface 211 and a second surface 212. Further, first substrate 210 may be fabricated from any one of a number of materials that are transparent or substantially transparent in the visible region of the electromagnetic spectrum, such as alumino-silicate glass, such as Falcon commercially available from AGC; boroaluminosilicate (“BAS”) glass; polycarbonate, such as ProLens® polycarbonate, commercially available from Professional Plastics, which may be hard coated; polyethylene terephthalate, such as but not limited to Spallshield® CPET available from Kuraray®; soda lime glass, such as ultra-clear soda lime glass; float glass; natural and synthetic polymeric resins and plastics, such as polyethylene (e.g., low and/or high density), polyethylene terephthalate (PET), polyethylene naphthalate (PEN), polycarbonate (PC), polysulfone, acrylic polymers (e.g., poly(methyl methacrylate) (PMMA)), polymethacrylates, polyimides, polyamides (e.g., a cycloaliphatic diamine dodecanedioic acid polymer (i.e., Trogamid® CX7323)), epoxies, cyclic olefin polymers (COP) (e.g., Zeonor 1420R), cyclic olefin copolymers (COC) (e.g., Topas 6013S-04 or Mitsui Apel), polymethylpentene, cellulose ester based plastics (e.g., cellulose triacetate), transparent fluoropolymer, polyacrylonitrile; and/or combinations thereof. While particular substrate materials are disclosed, for illustrative purposes only, numerous other substrate materials are likewise suitable—so long as the materials are at least substantially transparent and exhibit appropriate physical properties such as strength and tolerance to conditions of the device's environment, such as ultra-violet light exposure from the sun, humidity, and temperature extremes.

Second substrate 220 may be disposed in a substantially parallel spaced apart relationship with first substrate 210. Further, second substrate 220 comprises a third surface 223 and a fourth surface 224. Additionally, second substrate 220 may be disposed such that third surface 223 faces second surface 212 of first substrate 210. Also, second substrate 420 may be fabricated from similar materials as those suitable for first substrate 210.

First electrode 230 is an electrically conductive material associated with second surface 212. The electrically conductive material may be substantially transparent in the visible region of the electromagnetic spectrum and generally resistant to corrosion from materials contained in chamber 260. Accordingly, for example, the electrically conductive material may be a transparent conductive oxide (TCO) such fluorine doped tin oxide (FTO), indium tin oxide (ITO), or indium zinc oxide (IZO).

Similarly, second electrode 240 is an electrically conductive material associated with third surface 223. Further, the electrically conductive material of second electrode 240 may be comprised of the same materials as those suitable for first electrode 230. In some embodiments, second electrode 240 may comprise reflective element 280.

Seal 240 may be disposed between the first and second substrates 210, 220 in a peripheral manner to define a chamber 260 in combination with juxtaposed first and second electrodes 230, 240. Further, seal 250 may comprise any material capable of being adhesively bonded to first and second electrodes 230, 240 to in turn seal chamber 260, such that the electro-optic medium 270 may not inadvertently leak out. Additionally, seal 250 may extend to the second and/or third surfaces 212, 223. In such an embodiment, the first and second electrodes 230, 240 may be partially removed where seal 250 is positioned. Alternatively, sealing member 250 may be disposed about and extending between the peripheries of the first and second substrates 210, 220.

Electro-optic medium 270 may be disposed in chamber 260. In some embodiments, electro-optic medium 270 may be electrochromic. Further, electro-optic medium 270 is operable to enter and/or maintain an activated state upon exposure to an electrical potential. In an activated state, electro-optic medium 270 is operable to exhibit a change, relative an un-activated state, in its extinction coefficient at one or more wavelengths in the electromagnetic spectrum. In some embodiments, this change may occur in the visible region of the electromagnetic spectrum. Additionally, electro-optic medium 270 may be operable to transmit light in the first wavelength range while in both activated and un-activated sates. Accordingly, the change in extinction coefficient may occur at a wavelength outside of the first wavelength range.

Reflective element 280 may be a reflective coating. Typical coatings for this type of reflector include chromium, rhodium, ruthenium, silver, and combinations thereof. Further, reflective element 280 may be disposed between electro-optic medium 270 and cavity 110, such that light reflected therefrom must pass through electro-optic medium 270. In some embodiments, reflective element 280 may be associated with fourth surface 224. In other embodiments, reflective element 280 may be associated with third surface 223. In some such embodiments, reflective element 280 may be second electrode 240 and/or a part of second electrode 240. Accordingly, reflective element 280 may be electrically conductive.

Foam layer 300 may be associated with and/or substantially cover second side 202. Accordingly, foam layer 300 may, at least partially, form a barrier between transflective element 200 and a carrier plate operable to support transflective element 200. Thus, in some embodiments, foam layer 300 may be associated fourth surface 224. Further, foam layer 300 may comprise an aperture 310 therethrough. Additionally, foam layer 300 may comprise adhesives, epoxies, or other bonding agents to bind foam layer 300 to transflective element 200 and/or the carrier plate. Alternatively, the adhesives, epoxies, or other bonding agents may be disposed between foam layer 300 and transflective element 200 and/or the carrier plate. Further, foam layer 300 may minimize vibration, which in turn may minimize potential buzzing, squeaking, and/or rattling within housing 100.

Circuit board 400 may be disposed within cavity 110. In some embodiments, circuit board 400 may be disposed in a substantially parallel manner relative transflective element 200. For example, circuit board 400 may be a printed circuit board (PCB). Further, circuit board 400 may be configured and/or operable to provide electrical signals to and/or receive electrical signals from one or more electrical components connected thereto, such as transflective element 200, light source 500, imager 800, and/or a display. These signals may be configured and/or operable to control the electrical components.

Light source 500 may be disposed within cavity 110. Additionally, light source 500 may be configured and/or operable to emit light having a second wavelength range. The second wavelength range may be within the first wavelength range. In some embodiments, the second wavelength range may be substantially centered around 810, 850, or 940 nm. Further, the emitted light may be directed and/or transmitted through transflective element 200 to illuminate a passenger compartment of the vehicle and/or the driver. For example, light source 500, may comprise one or more light emitting diodes (LEDs); vertical cavity surface emitting lasers (VCELs); or halogen, quartz, incandescent, or compact fluorescent (“CFL”) light bulbs. Additionally, light source 500 may be physically associated with circuit board 400.

Optic apparatus 600 may be disposed within cavity 110. Further, optic apparatus 600 may have a collimator optic 610 and a spreader optic 620. Collimator optic 610 may be configured and/or operable to substantially collimate the light emitted from light source 500 toward transflective element 200 in substantial alignment with aperture 310. Accordingly, collimator optic 610 may be substantially disposed within cavity 110 and optically aligned with light source 500. To collimate may mean to direct the light rays in a substantially parallel configuration. Further, collimator optic 610 may be substantially parabolic. Spreader optic 620 may be disposed proximate second side 202. In some embodiments, spreader optic 620 may be physically associated with second side 202. Accordingly, spreader optic 620 may be optically aligned with and disposed between collimator optic 610 and transflective element 200. Additionally, spreader optic 620 may be disposed in substantial alignment with and/or substantially within aperture 310. Further, spreader optic 620 may be configured and/or operable to transmit and spread the collimated light. In some embodiments, spreader optic 620 may comprise a diffuser. Thus, spreader optic 620 may be operable to substantially diffuse the light transmitted therethrough. Additionally or alternatively, spreader optic 620 may comprise one or more prism film. Thus, spreader optic 620 may be operable to direct light transmitted therethrough substantially homogeneously within a horizontal and/or vertical angle. In some embodiments, collimator optic 610 and spreader optic 620 may be separate pieces. In other embodiments, collimator optic 610 and spreader optic 620 may be formed from a unitary piece. In some embodiments, optic apparatus 600 may be configured and/or operable to transmit and/or spread light therethrough, such that the illumination spreads by at least 75 or 80 degrees in both directions (i.e., positive and negative or right and left) from center in the X axis and/or 15 degrees up and 80 degrees down from center in the Y axis.

Light filter 700 may be optically disposed between collimator optic 610 and transflective element 200. In some embodiments, light filter 700 may be further optically disposed between collimator optic 610 and spreader optic 620. In other embodiments, light filter 700 may be further optically disposed between spreader optic 620 and transflective element 200. Thus, light filter 700 may be associated with second side 202. In yet other embodiments, light filter 700 may be disposed within transflective element 200 between reflective element 280 and spreader optic 620. Further, light filter 700 may be operable to substantially selectively block light having wavelengths lower than a first threshold. Thus, light filter 700, for example, may be a shortwave filter (i.e., a long-pass filter). The first threshold, for example, may be at or approximately at 935, 930, 925, 920 or 800, 805 nm.

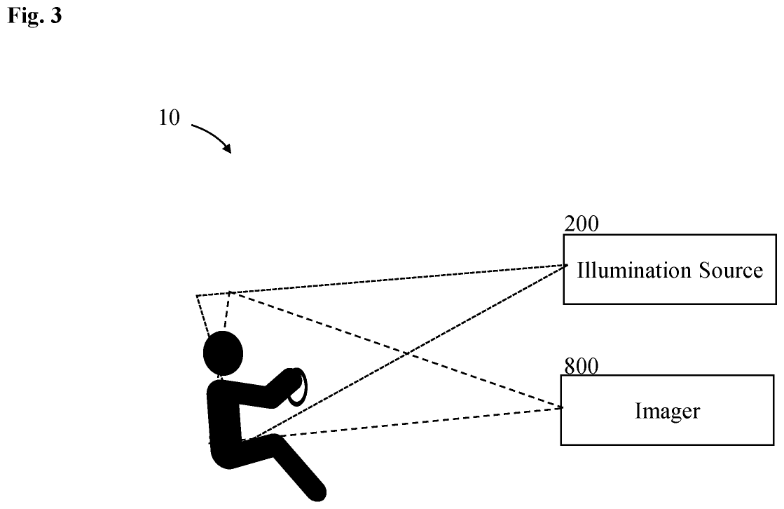

Imager 800, as shown in FIG. 3, The may be any device configured and/or operable to capture light in the second wavelength range and generate one or more corresponding images. For example, imager 800 may be a camera. Accordingly, imager 800 may be a Semi-Conductor Charge-Coupled Device (CCD) or a pixel sensor of Complementary Metal-Oxide-Semi-Conductor (CMOS) technologies. In some embodiments, imager 800 may have a field of view corresponding to the driver and/or the passenger compartment of the vehicle. In some embodiments, imager 800 may be positioned within the passenger compartment of the vehicle. In other embodiments, imager 800 may be disposed within cavity 110 proximate light source 500. Accordingly, imager 800 may be physically associated with circuit board 400. In such an embodiment, imager 800 may be operable to receive light in the second wavelength range transmitted through transflective element 200. Thus, imager 800 may be configured and/or operable to receive light from light source 300 after reflection off the passenger compartment and/or the driver.

In operation, light source 500 may emit light, which may in turn be guided by optic apparatus 600. Specifically, the emitted light may be substantially collimated by collimator optic 510. Additionally, the collimated light may then be transmitted through spreader optic 520 and spread about horizontal and/or vertical angles. Subsequently, the spread light may be transmitted through transflective element 200, reflected off the passenger compartment and/or the driver, and captured by imager 800.

Embodiments of illumination and imaging system 10 may have several advantages. One substantial advantage is an improved aesthetic where light source 500 is associated with a circuit board 400 having a substantial set-back from transflective element 200. In prior systems, the cross-sectional area of the illumination transmitted through transflective element 200 increases with increasing distance between transflective element 200 and light source 500. Further, where light source 500 is physically associated with circuit board 400, a substantial set-back of circuit board 400 likewise increases the distance between transflective element 200 and light source 500. Thus, the illuminated portion of transflective element 200 was also increased. Furthermore, the larger the illuminated portion, the more easily visible it is and, thus, the less aesthetically pleasing the design. However, a substantial set-back may be required when utilizing a construction where light source 500 and imager 800 are both physically associated with a single circuit board 400, as imager 800 may require substantial space between circuit board 400 and transflective element 200 to fit.

In embodiments of illumination and imaging system 10, the aesthetic is improved even in designs with a substantial set-back of circuit board 400 relative transflective element 200. The improved aesthetic may be achieved because the cross-sectional area of the illumination is decreased at transflective element 200. This area may be decreased by collimator optic 610, which directs the emitted light in a substantially collimated fashion, preventing the spread of the light and thus reducing growth in the cross-sectional areas of the emission cone for a set distance between light source 500 and transflective element 200. Further, spreader optic 620 also allows for a substantial emission angle of the illumination, such that the interior is still adequately illuminated. Additionally, reducing the cross-sectional size of the illuminated at transflective element 200, allows for a smaller aperture 310 in foam layer 300 and/or a smaller spreader optic 620. The smaller aperture 310 may be used because the size of aperture 310 may be proportional to the size of spreader optic 620. Further, a smaller spreader optic 620 may be used, because spreader optic 510, generally, must be so wide as to substantially capture the entire cross-sectional area of the cone of the illumination.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

In this document, relational terms, such as “first,” “second,” and the like, are used solely to distinguish one entity or action from another entity or action, without necessarily requiring or implying any actual such relationship or order between such entities or actions.

For purposes of this disclosure, the term “associated” generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

The term “substantially,” and variations thereof, will be understood by persons of ordinary skill in the art as describing a feature that is equal or approximately equal to a value or description. For example, a “substantially planar” surface is intended to denote a surface that is planar or approximately planar. Moreover, “substantially” is intended to denote that two values are equal or approximately equal. If there are uses of the term which are not clear to persons of ordinary skill in the art, given the context in which it is used, “substantially” may denote values within about 10% of each other, such as within about 5% of each other, or within about 2% of each other.

The term “transflective” generally refers to an optical configuration that reflects at least a portion of light incident from at least one side and transmits at least a portion of light incident from at least one side. In particular, “transflective” describes an optical element or component that has a non-zero level of transmittance with regard to a wave range of light and also has a non-zero level of reflectance in a region. The applicable wave range of light will vary based on the context. However, in the event the relevant wave range of light is not readily apparent, the wave range in light shall generally refer to visible light.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

1. A rearview assembly, comprising:
a housing having a cavity with an opening;
a transflective element substantially aligned with the opening, the transflective element having a first side directed exterior the cavity and a second side directed interior the cavity;
a light source disposed within the cavity and configured to emit at least one of infra-red and near infra-red light; and
an optic apparatus disposed within the cavity, the optic apparatus having:
a collimator optic configured to collimate the emitted light toward the transflective element, and
a spreader optic disposed proximate the second side and configured to transmit and spread the collimated light;
wherein the spread light is transmitted through the transflective element to substantially illuminate a vehicle interior.

2. The rearview assembly of claim 1, further comprising:
a foam layer associated with the second side, the foam layer having an aperture;
wherein the spreader optic is substantially disposed within the aperture.

3. The rearview assembly of claim 1, further comprising a circuit board having a substantial set-back from the transflective element, wherein the light source is physically associated with the circuit board.

4. The rearview assembly of claim 3, further comprising an imager disposed within the cavity, the imager physically associated with the circuit board.

5. The rearview assembly of claim 1, wherein the transflective element comprises an electrochromic element operable to vary the reflectance of the transflective element.

6. The rearview assembly of claim 1, wherein the spreader optic comprises a diffuser.

7. The rearview assembly of claim 1, wherein the spreader optic comprises one or more prism film.

8. The rearview assembly of claim 1, wherein the light is spread by at least 75 degrees in both directions from center in an X axis, where the X axis corresponds to a horizontal direction in relation to looking directly at the first side under normal operating conditions.

9. The rearview assembly of claim 1, wherein the light is spread by at least 15 degrees up and 80 degrees down from center in a Y axis, where the Y axis corresponds to a vertical direction in relation to looking directly at the first side under normal operating conditions.
